(19) United States
(12) Patent Application Publication
(10) Pub. No.: US 2026/0264266 A1
(43) Pub. Date: Sep. 10, 2026

(54) MECHANICAL CHUCK

(71) Applicant: SUMITOMO ELECTRIC INDUSTRIES, LTD., Osaka (JP)

(72) Inventor: Michio SUZUKI, Osaka (JP)

(21) Appl. No.: 19/551,815

(22) Filed: Feb. 27, 2026

(30) Foreign Application Priority Data
Mar. 4, 2025 (JP) 2025-034003

(51) Int. Cl. B25J 15/02; B23Q 3/06; B25J 15/08

(52) U.S. Cl. CPC B25J 15/026; B23Q 3/06; B25J 15/08

(57) ABSTRACT

A mechanical chuck according to one embodiment includes a rotary member including a rotary shaft, a first threaded portion and a second threaded portion; and a first arm and a second arm that move along the axis as the rotary member rotates. The first arm includes a first latch portion that engages with the first threaded portion, and a first gripping portion that moves along the axis together with the first latch portion, and the second arm includes a second latch portion that engages with the second threaded portion, and a second gripping portion that moves along the axis together with the second latch portion. The first gripping portion and the second gripping portion move along the axis in opposite directions as the rotary member rotates.

### CROSS REFERENCE TO RELATED APPLICATIONS

This application claims priority based on Japanese Patent Application No. 2025-034003 filed on Mar. 4, 2025, and the entire contents of the Japanese patent application are incorporated herein by reference.

### TECHNICAL FIELD

The present disclosure relates to a mechanical chuck.

### BACKGROUND

Japanese Unexamined Utility Model Publication No. S62-188379 discloses a mechanical chuck for handling a substrate on which electronic components are mounted. The mechanical chuck includes a pair of claws for chucking a workpiece; a slide block and a pin connected to one of the pair of claws; a lever that pushes the pin along a horizontal direction; and an air cylinder that actuates the lever. When the air cylinder actuates the lever, the pin and the slide block move in the horizontal direction, thereby closing the pair of claws.

Japanese Unexamined Publication No. 2017-34492 discloses a manipulator that grips a VOA base, which is one of the components of a coherent optical receiver module. The manipulator includes two arms, the positions and angles of which can be freely changed, and a pair of arm heads provided at tips of the respective arms. The VOA base includes a pair of metal bodies. When the pair of arm heads grip the VOA base, the pair of arm heads are electrically connected to the pair of respective metal bodies. At this time, a voltage is applied between the pair of metal bodies via the arms and the arm heads of the manipulator.

Japanese Unexamined Publication No. H7-186081 discloses a mechanical chuck attached to a mounting head of an electronic component mounting device. The mechanical chuck includes a nozzle body and a chuck portion. The chuck portion includes two piston members that are movable, and two gripping claws that move in conjunction with the respective two piston members. A lateral hole is formed in the nozzle body. When suction means performs suction to create negative pressure in the lateral hole, the two piston members are drawn toward the center. Accordingly, the two gripping claws are brought into a closed state.

### SUMMARY

A mechanical chuck according to the present disclosure includes a rotary member including a rotary shaft, a first threaded portion that is a portion in which thread grooves are formed on the rotary shaft and which extends along an axis of the rotary shaft, and a second threaded portion that is a portion in which thread grooves are formed on the rotary shaft and which is configured to be plane-symmetrical to the first threaded portion with respect to a vertical plane perpendicular to the rotary shaft; and a first arm and a second arm that move along the axis as the rotary member rotates. The first arm includes a first latch portion that engages with the first threaded portion, and a first gripping portion that moves along the axis together with the first latch portion. The second arm includes a second latch portion that engages with the second threaded portion, and a second gripping portion that moves along the axis together with the second latch portion. The first gripping portion and the second gripping portion move along the axis in opposite directions as the rotary member rotates.

### BRIEF DESCRIPTION OF THE DRAWINGS

FIG. 1 is a perspective view illustrating a mechanical chuck according to an embodiment.

FIG. 2 is a front view illustrating the mechanical chuck according to the embodiment.

FIG. 3 is an enlarged perspective view of a first threaded portion, a second threaded portion, a first latch portion, and a second latch portion of the mechanical chuck illustrated in FIG. 1.

FIG. 4 is a perspective view illustrating a first gripping portion, a second gripping portion, and an optical component of the mechanical chuck illustrated in FIG. 1.

FIG. 5 is a side view illustrating the first gripping portion, the second gripping portion, and the optical component illustrated in FIG. 4.

FIG. 6 is a side view schematically illustrating opening and closing operations of the first gripping portion and the second gripping portion with respect to the optical component.

FIG. 7 is a side view of a rotary shaft, the first threaded portion, and the second threaded portion of the mechanical chuck illustrated in FIG. 1.

FIG. 8 is a perspective view illustrating the first latch portion illustrated in FIG. 3.

FIG. 9 is a perspective view illustrating a mechanical chuck according to a modification example.

FIG. 10 is a perspective view illustrating an example of an optical component gripped by the mechanical chuck illustrated in FIG. 9.

### DETAILED DESCRIPTION

A mechanical chuck may grip a minute component. When gripping such a minute component, it is required to grip the minute component with an appropriate gripping force in order to prevent damage to the component.

An object of the present disclosure is to provide a mechanical chuck capable of gripping a minute component with an appropriate gripping force.

According to the present disclosure, a minute component can be gripped with an appropriate gripping force.

First, embodiments of a mechanical chuck according to the present disclosure will be listed and described. (1) A mechanical chuck according to the present embodiment includes a rotary member including a rotary shaft, a first threaded portion that is a portion in which thread grooves are formed on the rotary shaft and which extends along an axis of the rotary shaft, and a second threaded portion that is a portion in which thread grooves are formed on the rotary shaft and which is configured to be plane-symmetrical to the first threaded portion with respect to a vertical plane perpendicular to the rotary shaft; and a first arm and a second arm that move along the axis as the rotary member rotates. The first arm includes a first latch portion that engages with the first threaded portion, and a first gripping portion that moves along the axis together with the first latch portion. The second arm includes a second latch portion that engages with the second threaded portion, and a second gripping portion that moves along the axis together with the second latch portion. The first gripping portion and the second gripping portion move along the axis in opposite directions as the rotary member rotates.

In the mechanical chuck, the first threaded portion and the second threaded portion are formed on the rotary shaft of the rotary member, and the first arm and the second arm move along the axis as the rotary member rotates. In the first arm, the first latch portion engages with the first threaded portion, and the first gripping portion moves along the axis together with the first latch portion. In the second arm, the second latch portion engages with the second threaded portion, and the second gripping portion moves along the axis together with the second latch portion. The first threaded portion and the second threaded portion are formed so as to be plane-symmetrical to each other with respect to the vertical plane perpendicular to the rotary shaft, the first latch portion engages with the first threaded portion, and the second latch portion engages with the second threaded portion. Therefore, when the rotary member rotates, the first gripping portion and the second gripping portion move along the axis in opposite directions at the same speed. Therefore, when the rotary member rotates with the first gripping portion and the second gripping portion located on both sides of a component, the first gripping portion and the second gripping portion are capable of approaching each other with respect to the component at the same speed at a low speed. As a result, the component can be gripped between the first gripping portion and the second gripping portion with an appropriate gripping force.

(2) In (1) above, the first latch portion may ride over thread ridges of the first threaded portion when the first gripping portion, as the first gripping portion moves along the axis, receives a reaction force that hinders the movement. The second latch portion may ride over thread ridges of the second threaded portion when the second gripping portion, as the second gripping portion moves along the axis, receives a reaction force that hinders the movement. In this case, when the first gripping portion receives a reaction force, the first latch portion rides over the thread ridges of the first threaded portion, and when the second gripping portion receives a reaction force, the second latch portion rides over the thread ridges of the second threaded portion. Therefore, when the first gripping portion and the second gripping portion further approach each other with the component gripped between the first gripping portion and the second gripping portion, the first latch portion and the second latch portion ride over the thread ridges due to resistance, thereby being able to prevent an excessive gripping force from being applied to the component. Therefore, the gripping force applied to the component can be further optimized.

(3) In (1) or (2) above, the first latch portion may include a first protrusion that engages with the thread grooves of the first threaded portion. The second latch portion may include a second protrusion that engages with the thread grooves of the second threaded portion. The first protrusion may move along the axis by moving along the thread grooves of the first threaded portion when the first threaded portion rotates. The second protrusion may move along the axis in a direction opposite to the first protrusion by moving along the thread grooves of the second threaded portion when the second threaded portion rotates. In this case, the first protrusion of the first latch portion and the second protrusion of the second latch portion move along the respective thread grooves, thereby enabling the first gripping portion and the second gripping portion to move with high accuracy. Therefore, the gripping force applied by the first gripping portion and the second gripping portion can be adjusted with high accuracy.

(4) In any one of (1) to (3) above, the mechanical chuck may include a guide member that guides the movement of the first arm along the axis and the movement of the second arm along the axis. In this case, the movement of the first gripping portion of the first arm and the second gripping portion of the second arm along the axis can be stabilized.

A specific example of a mechanical chuck according to an embodiment of the present disclosure will be described below with reference to the drawings. In the description of the drawings, the same or corresponding elements are denoted by the same reference signs, and redundant descriptions are omitted as appropriate. The drawings may be depicted in a partially simplified or exaggerated manner for ease of understanding, and dimensional ratios and the like are not limited to those illustrated in the drawings.

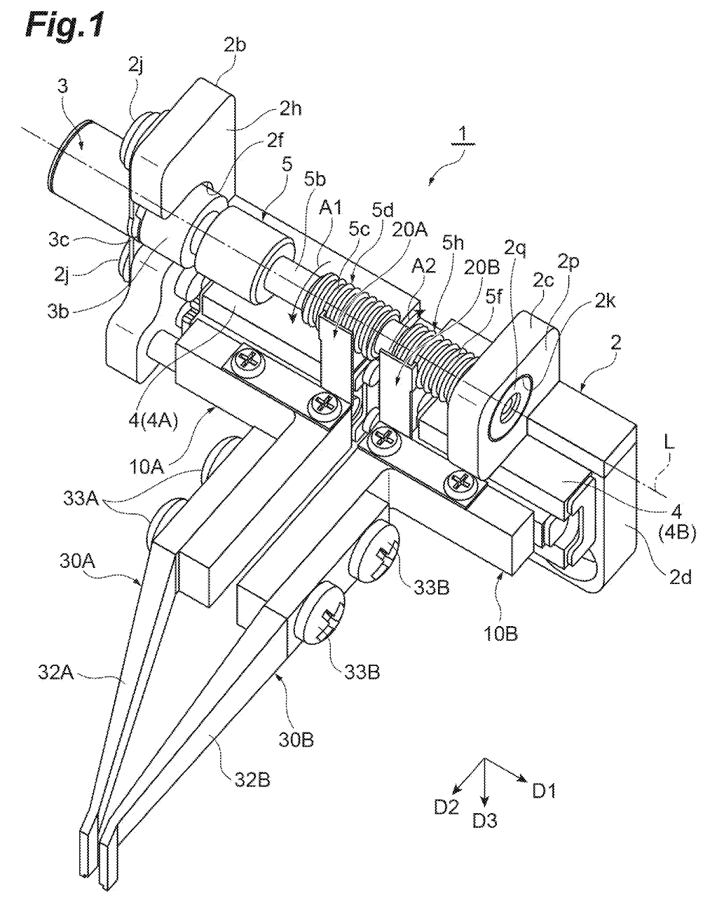

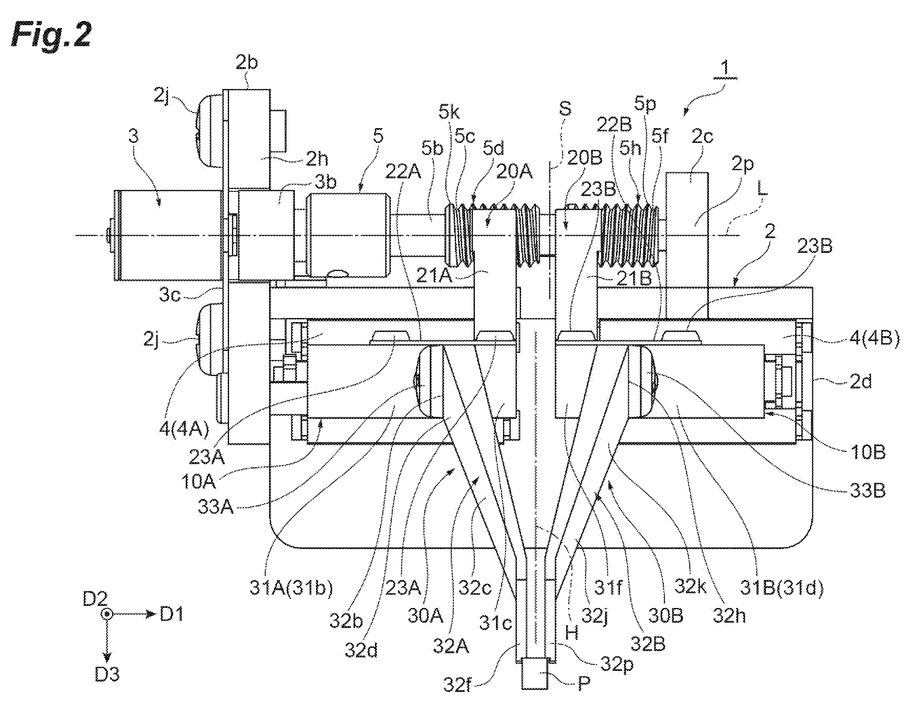

FIG. 1 is a perspective view illustrating a mechanical chuck 1 according to an embodiment. FIG. 2 is a front view illustrating the mechanical chuck 1. The mechanical chuck 1 grips a minute component P. The minute component P is, for example, a component having a volume of 0.5 mm³ or more and 5 mm³ or less. For example, the component P is an optical component. The mechanical chuck 1 includes, for example, a base 2, a motor 3, a guide member 4, a rotary member 5, a first arm 10A, and a second arm 10B. The motor 3, the guide member 4, and the rotary member 5 are fixed to the base 2.

In the present embodiment, in the following description, a direction in which the rotary member 5 is located with respect to the motor 3 is referred to as a first direction D1, a direction in which the guide member 4 is located with respect to the base 2 is referred to as a second direction D2, and a direction in which the guide member 4 is located with respect to the rotary member 5 is referred to as a third direction D3. The first direction D1, the second direction D2, and the third direction D3 intersect each other (as one example, are orthogonal to each other). In addition, hereinafter, the third direction D3 may be referred to as bottom or down, and a direction opposite to the third direction D3 may be referred to as top or up. However, these directions are provided for convenience of description, and do not limit the disposition position, orientation, or the like of an object.

For example, the length of the base 2 in the first direction D1 is larger than the length of the base 2 in the third direction D3, and the length of the base 2 in the third direction D3 is larger than the length of the base 2 in the second direction D2. The base 2 includes a first attachment portion 2b to which the motor 3 is attached; a second attachment portion 2c to which the rotary member 5 is attached; and a third attachment portion 2d to which the guide member 4 is attached. The first attachment portion 2b includes, for example, a plate-shaped portion 2h having a recess 2f recessed in a direction opposite to the second direction D2, and screws 2j. The motor 3 includes a first portion 3b passing through the recess 2f in the first direction D1, and a second portion 3c protruding from the first portion 3b in the third direction D3 and in the direction opposite to the third direction D3. The first attachment portion 2b includes two screws 2j aligned in the third direction D3. The first attachment portion 2b fixes the motor 3 to the base 2 by passing the screws 2j through the second portion 3c.

The second attachment portion 2c includes, for example, a plate-shaped portion 2p having a through-hole 2k penetrating therethrough in the first direction D1, and a rotation support portion 2q fitted into the through-hole 2k. An end portion of the rotary member 5 in the first direction D1 is inserted into the rotation support portion 2q. The rotary member 5 is rotatably supported by the second attachment portion 2c. The rotary member 5 rotates about an axis L passing through the center of the rotary member 5 and extending along a longitudinal direction of the rotary member 5. The third attachment portion 2d extends in both the first direction D1 and the third direction D3, and has a thickness in the second direction D2. For example, the guide member 4 is fixed to the third attachment portion 2d by screws (not illustrated).

The motor 3 is located at an end portion of the rotary member 5 in a direction opposite to the first direction D1. The motor 3 rotates the rotary member 5. The motor 3 is, for example, a geared motor. In this case, the motor 3 is capable of rotating the rotary member 5 at low speed and high torque. However, the motor 3 may be a stepping motor, and the type of the motor 3 is not particularly limited. For example, the time required for the rotary member 5 to make one rotation by driving the motor 3 is greater than 1 second and less than or equal to 10 seconds (as one example, 5 seconds). The torque of the motor 3 is, for example, 2 Nm or more and 6 Nm or less. The torque of the motor 3 may be variable.

The guide member 4 guides movement of the first arm 10A along the axis L and movement of the second arm 10B along the axis L. For example, the mechanical chuck 1 includes a plurality of the guide members 4 aligned along the first direction D1. The plurality of guide members 4 include a first guide member 4A and a second guide member 4B located in the first direction D1 relative to the first guide member 4A. The first guide member 4A supports the first arm 10A so as to be movable along the axis L, and the second guide member 4B supports the second arm 10B so as to be movable along the axis L. For example, the guide members 4 include built-in ball bearings. In this case, the movement of the first arm 10A and the second arm 10B along the axis L can be smoothly performed.

The rotary member 5 includes a rotary shaft 5b; a first threaded portion 5d that is a portion in which thread grooves 5c are formed on the rotary shaft 5b and which extends along the axis L of the rotary shaft 5b; and a second threaded portion 5h that is a portion in which thread grooves 5f are formed on the rotary shaft 5b and which is configured to be plane-symmetrical to the first threaded portion 5d with respect to a vertical plane S perpendicular to the rotary shaft 5b. The rotary shaft 5b has, for example, a columnar shape. The rotary shaft 5b extends along the first direction D1. The thread grooves 5c of the first threaded portion 5d extend in a first helical direction A1 about the axis L, and the thread grooves 5f of the second threaded portion 5h extend in a second helical direction A2 about the axis L, the second helical direction A2 being opposite to the first helical direction A1. The pitch of the thread grooves 5c of the first threaded portion 5d is equal to the pitch of the thread grooves 5f of the second threaded portion 5h. The rotary member 5 will be described in detail later.

The first arm 10A and the second arm 10B move along the axis L as the rotary member 5 rotates. In the present embodiment, the first arm 10A and the second arm 10B are shaped symmetrically to each other with respect to an imaginary plane H that is orthogonal to the first direction D1 at an intermediate position between the first arm 10A and the second arm 10B. The first arm 10A includes a first latch portion 20A that engages with the first threaded portion 5d, and a first gripping portion 30A that moves along the axis L together with the first latch portion 20A. The second arm 10B includes a second latch portion 20B that engages with the second threaded portion 5h, and a second gripping portion 30B that moves along the axis L together with the second latch portion 20B.

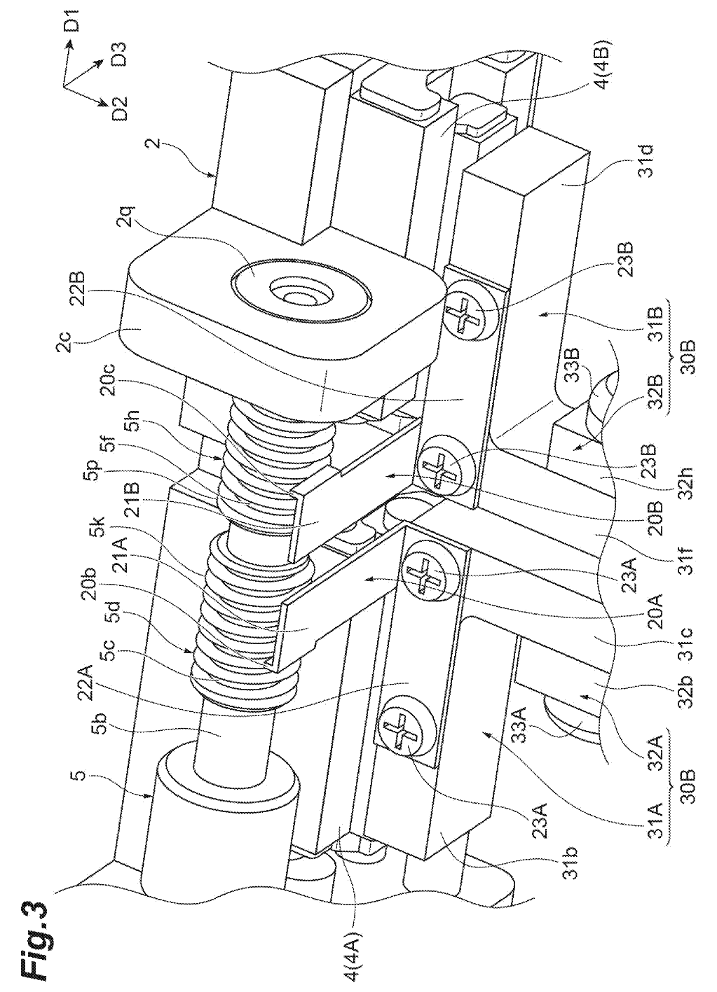

FIG. 3 is a partial enlarged perspective view of the rotary member 5, the first latch portion 20A, the second latch portion 20B, the first gripping portion 30A, and the second gripping portion 30B. As illustrated in FIGS. 2 and 3, the first latch portion 20A includes a plate-shaped portion 21A facing the first threaded portion 5d, and a plate-shaped portion 22A fixed to the first gripping portion 30A. The plate-shaped portion 21A extends in the first direction D1 and the third direction D3, and has a thickness in the second direction D2. The plate-shaped portion 21A faces the first threaded portion 5d along the second direction D2. The plate-shaped portion 22A extends in the second direction D2 and in the direction opposite to the first direction D1 from an end portion of the plate-shaped portion 21A in the third direction D3. The plate-shaped portion 22A extends in the first direction D1 and the second direction D2, and has a thickness in the third direction D3. For example, the plate-shaped portion 22A is fixed to the first gripping portion 30A by screws 23A. For example, the first latch portion 20A includes a plurality of the screws 23A, and the plurality of screws 23A are aligned along the first direction D1.

The second latch portion 20B is shaped symmetrically to the first latch portion 20A with respect to the imaginary plane H. The second latch portion 20B includes a plate-shaped portion 21B facing the second threaded portion 5h, and a plate-shaped portion 22B fixed to the second gripping portion 30B. The plate-shaped portion 22A faces the second threaded portion 5h along the second direction D2. The plate-shaped portion 22B extends in the second direction D2 and the first direction D1 from an end portion of the plate-shaped portion 21B in the third direction D3. For example, the plate-shaped portion 22B is fixed to the second gripping portion 30B by screws 23B. For example, the number and disposition mode of the screws 23B are the same as the number and disposition mode of the screws 23A. The first latch portion 20A and the second latch portion 20B will be described in detail later.

The first gripping portion 30A includes a first slide portion 31A to which the first latch portion 20A (the plate-shaped portion 22A) is fixed and which is supported by the first guide member 4A so as to be movable along the axis L, and a first claw portion 32A extending from the first slide portion 31A in the second direction D2. The first slide portion 31A includes a facing portion 31b facing the first guide member 4A, and a protruding portion 31c protruding from the facing portion 31b in the second direction D2. The facing portion 31b has, for example, a rectangular parallelepiped shape. The length of the facing portion 31b in the first direction D1 is larger than the length of the facing portion 31b in the second direction D2, and is larger than the length of the facing portion 31b in the third direction D3. For example, the protruding portion 31c protrudes in the second direction D2 from an end portion of the facing portion 31b in the first direction D1. For example, the protruding portion 31c has a rectangular parallelepiped shape. The length of the protruding portion 31c in the second direction D2 is larger than the length of the protruding portion 31c in the first direction D1, and is larger than the length of the protruding portion 31c in the third direction D3.

The first claw portion 32A includes a first fixing portion 32b fixed to the first slide portion 31A (the protruding portion 31c), and a first linear portion 32c extending from the first fixing portion 32b in the second direction D2. The first fixing portion 32b has, for example, a rectangular parallelepiped shape. The length of the first fixing portion 32b in the second direction D2 is larger than the length of the first fixing portion 32b in the first direction D1, and is larger than the length of the first fixing portion 32b in the third direction D3. The first fixing portion 32b is fixed to a surface of the protruding portion 31c that faces the direction opposite to the first direction D1. For example, the first gripping portion 30A includes screws 33A for fixing the first fixing portion 32b to the protruding portion 31c. For example, the first gripping portion 30A includes a plurality of the screws 33A, and the plurality of screws 33A are aligned along the second direction D2.

The first linear portion 32c includes a first extending portion 32d extending from the first fixing portion 32b in the second direction D2, and a first tip portion 32f located at an end portion of the first extending portion 32d opposite to the first fixing portion 32b. For example, the first extending portion 32d tapers from the first fixing portion 32b toward the first tip portion 32f. For example, the first extending portion 32d extends toward a second extending portion 32k to be described later in a direction inclined with respect to the first direction D1 and the second direction D2. For example, the inclination angle of an extending direction of the first extending portion 32d with respect to the second direction D2 is 20° or more and 40° or less. By inclining the first extending portion 32d of the first linear portion 32c in this manner, the first linear portion 32c can be prevented from becoming an obstruction. The distance between the first extending portion 32d and the second extending portion 32k decreases toward the second direction D2. The first extending portion 32d extends obliquely downward as the first extending portion 32d extends away from the first fixing portion 32b. The first tip portion 32f extends along the third direction D3 from the end portion of the first extending portion 32d opposite to the first fixing portion 32b. The component P comes into contact with an end portion of the first tip portion 32f in the third direction D3.

The second gripping portion 30B is shaped symmetrically to the first gripping portion 30A with respect to the imaginary plane H. The second gripping portion 30B includes a second slide portion 31B to which the second latch portion 20B (the plate-shaped portion 22B) is fixed and which is supported by the second guide member 4B so as to be movable along the axis L, and a second claw portion 32B extending from the second slide portion 31B in the second direction D2. The second slide portion 31B includes a facing portion 31d facing the second guide member 4B, and a protruding portion 31f protruding from the facing portion 31d in the second direction D2.

The second claw portion 32B includes a second fixing portion 32h fixed to the second slide portion 31B (the protruding portion 31f), and a second linear portion 32j extending from the second fixing portion 32h in the second direction D2. The second fixing portion 32h is fixed to a surface of the protruding portion 31f that faces the first direction D1. For example, the second gripping portion 30B includes screws 33B for fixing the second fixing portion 32h to the protruding portion 31f. The second linear portion 32j includes a second extending portion 32k extending from the second fixing portion 32h in the second direction D2, and a second tip portion 32p located at an end portion of the second extending portion 32k opposite to the second fixing portion 32h. The component P comes into contact with an end portion of the second tip portion 32p in the third direction D3.

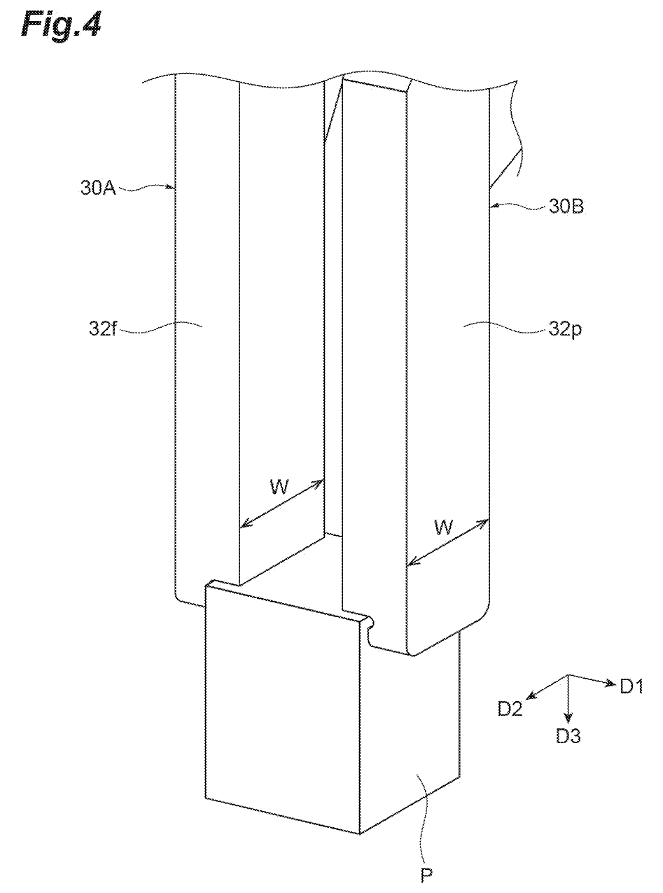

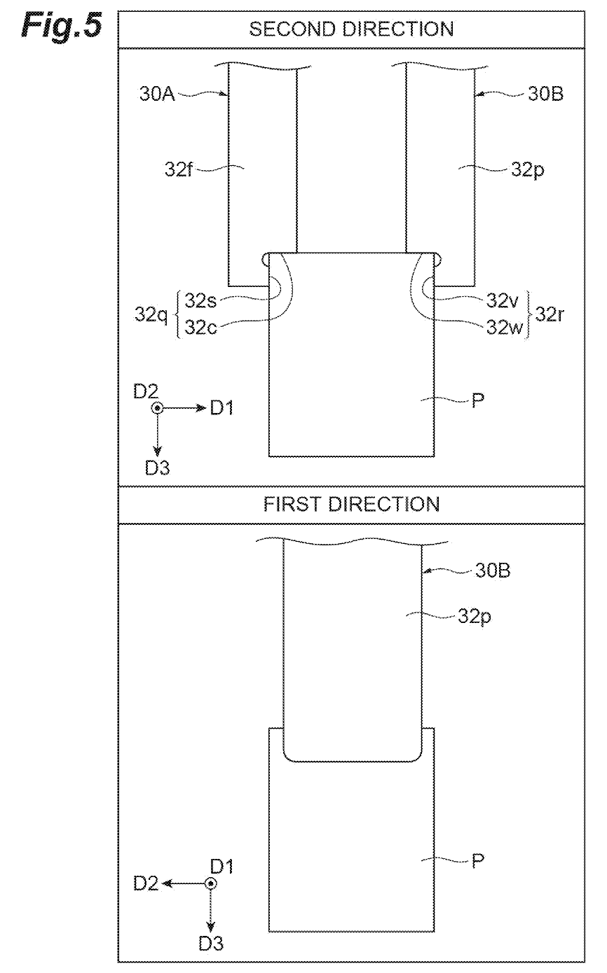

FIG. 4 is an enlarged perspective view of the first tip portion 32f, the second tip portion 32p, and the component P. FIG. 5 is a side view of the first gripping portion 30A (the first tip portion 32f) and the second gripping portion 30B (the second tip portion 32p) as viewed along the second direction D2, and a side view of the first gripping portion 30A (the first tip portion 32f) and the second gripping portion 30B (the second tip portion 32p) as viewed along the first direction D1. As illustrated in FIGS. 4 and 5, the width W (the length in the second direction D2) of the first tip portion 32f (the second tip portion 32p) is, for example, approximately 1 mm. The first tip portion 32f of the first gripping portion 30A has a first recess 32q that the component P enters, and the second tip portion 32p of the second gripping portion 30B has a second recess 32r that the component P enters.

The first recess 32q is formed by a side surface 32s extending upward from an end portion of the first tip portion 32f that is located in the first direction D1 and the third direction D3, and a lower surface 32t extending from an upper end of the side surface 32s in the first direction D1. The second recess 32r is formed by a side surface 32v extending upward from an end portion of the second tip portion 32p that is located in the direction opposite to the first direction D1 and in the third direction D3, and a lower surface 32w extending from an upper end of the side surface 32v in the direction opposite to the first direction D1. When viewed along the second direction D2, each of the first recess 32q and the second recess 32r has an L shape.

Unlike the present embodiment, when the component P is suctioned by a suction collet, the component P tilts when a force of 1 to 2 g is applied in the first direction D1 or the second direction D2. In contrast, when the first gripping portion 30A and the second gripping portion 30B grip the component P with the component P sandwiched between the first recess 32q and the second recess 32r, the component P can be prevented from tilting even when a force of approximately 5 to 7 g is applied. The gripping force applied by the first gripping portion 30A and the second gripping portion 30B is, for example, 10 g or more and 20 g or less (as one example, 14 g).

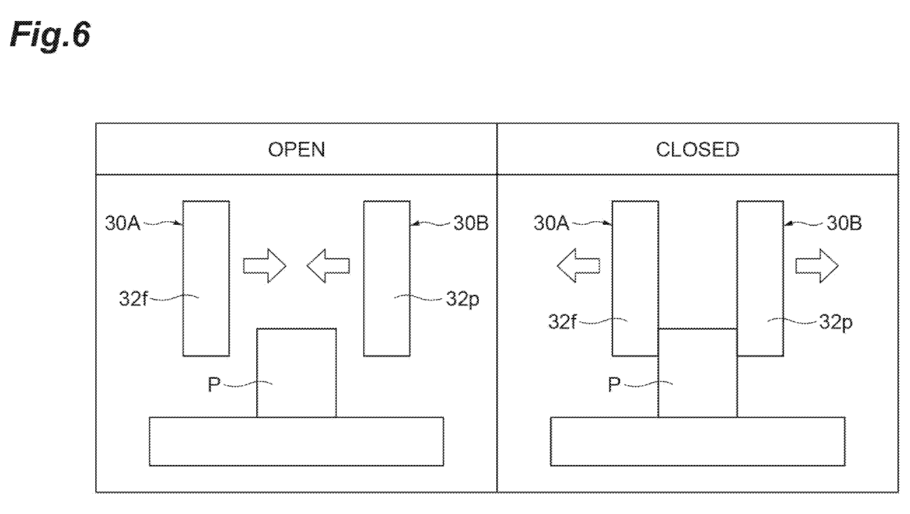

FIG. 6 is a side view schematically illustrating the movement of the first gripping portion 30A (the first tip portion 32f) and the second gripping portion 30B (the second tip portion 32p). As illustrated in FIG. 6, the first gripping portion 30A and the second gripping portion 30B open and close when gripping the component P. More specifically, the first gripping portion 30A and the second gripping portion 30B are disposed to sandwich the component P therebetween at positions where the distance from the component P to the first gripping portion 30A and the distance from the component P to the second gripping portion 30B are substantially equal.

Then, the motor 3 described above rotates the rotary member 5, thereby causing the first gripping portion 30A and the second gripping portion 30B to approach each other to grip the component P. In addition, the motor 3 rotates the rotary member 5 in an opposite direction, thereby causing the first gripping portion 30A and the second gripping portion 30B to move away from each other to release the gripping of the component P. In this manner, the first gripping portion 30A and the second gripping portion 30B move along the axis L described above in opposite directions as the rotary member 5 rotates. At this time, the first gripping portion 30A and the second gripping portion 30B move in the opposite directions at the same timing, thereby being able to prevent the occurrence of distortion in the component P when gripping the component P.

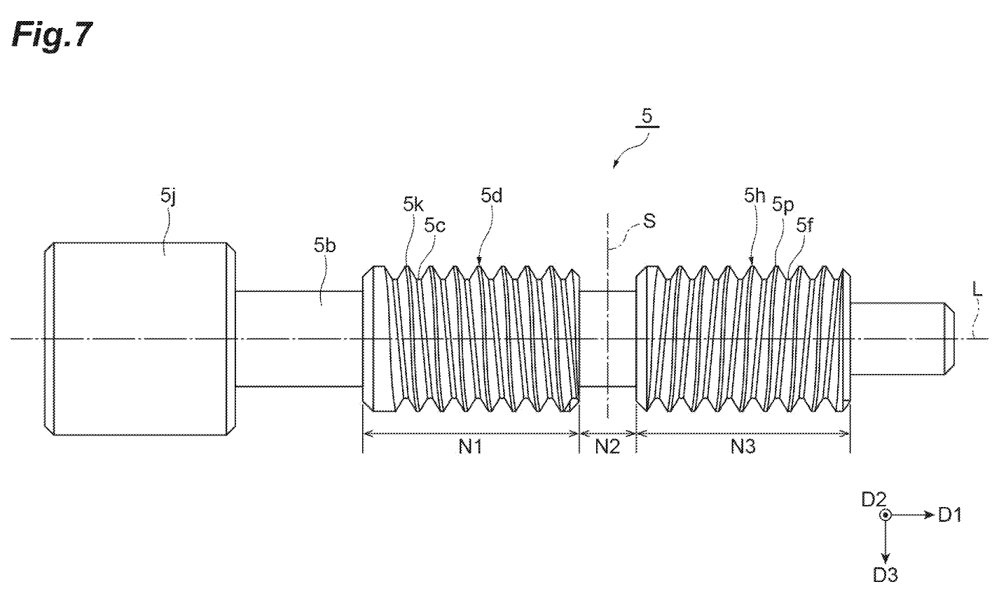

Hereinafter, the rotary member 5 will be described in more detail with reference to FIG. 7. As illustrated in FIG. 7, the rotary member 5 includes, for example, a motor connecting portion 5j that is a portion to which the motor 3 is connected. The motor connecting portion 5j has, for example, a cylindrical shape. The rotary shaft 5b extends from the motor connecting portion 5j in a direction opposite to the motor 3. The diameter of the motor connecting portion 5j is larger than the diameter of the rotary shaft 5b. The motor 3 rotates the motor connecting portion 5j, thereby causing the rotary shaft 5b to rotate about the axis L.

As one example, the first threaded portion 5d and the second threaded portion 5h are either M2 threads or M3 threads. The first threaded portion 5d is formed at a position spaced apart from the motor connecting portion 5j, and the second threaded portion 5h is formed at a position spaced apart from the first threaded portion 5d. The motor connecting portion 5j, the first threaded portion 5d, and the second threaded portion 5h are aligned in this order along the first direction D1. The first threaded portion 5d is formed by thread ridges 5k and the thread grooves 5c extending helically on the rotary shaft 5b. The spacing (pitch) of the thread ridges 5k aligned along the first direction D1 is, for example, 0.25 mm or more and 0.5 mm or less. The angle of the thread ridges 5k (the thread angle of the thread ridges 5k) is, as one example, 60°. The length N1 of the first threaded portion 5d in the first direction D1 is, for example, 1 mm or more and 9 mm or less (as one example, 4.5 mm).

The distance N2 from the first threaded portion 5d to the second threaded portion 5h is, for example, 1 mm or more and 1.5 mm or less (as one example, 1.2 mm). The second threaded portion 5h is formed by thread ridges 5p and the thread grooves 5f extending helically on the rotary shaft 5b in a direction opposite to the first threaded portion 5d. The second threaded portion 5h is configured to be plane-symmetrical to the first threaded portion 5d with respect to the vertical plane S perpendicular to the first direction D1 at the intermediate position between the first threaded portion 5d and the second threaded portion 5h. The length N3 of the second threaded portion 5h in the first direction D1 is, for example, 1 mm or more and 9 mm or less (as one example, 4.5 mm).

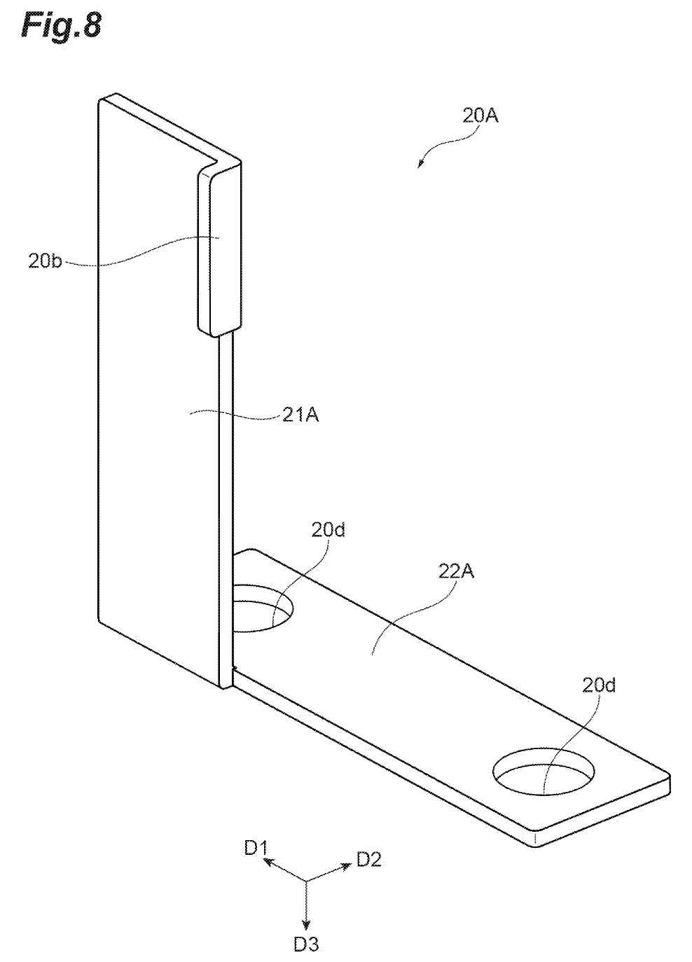

FIG. 8 is a perspective view illustrating the first latch portion 20A. As illustrated in FIGS. 3 and 8, the first latch portion 20A includes a first protrusion 20b that engages with the thread grooves 5c of the first threaded portion 5d. The first protrusion 20b moves along the thread grooves 5c with the first protrusion 20b having entered the thread grooves 5c of the first threaded portion 5d. Accordingly, the first latch portion 20A and the first gripping portion 30A move along the axis L. The first protrusion 20b protrudes from the plate-shaped portion 21A in the direction opposite to the second direction D2. The first protrusion 20b is located at an end portion of the plate-shaped portion 21A opposite to the first direction D1. The first protrusion 20b extends along the third direction D3 from an end portion of the plate-shaped portion 21A in the direction opposite to the third direction D3. The length of the first protrusion 20b in the third direction D3 is smaller than the length of the plate-shaped portion 21A in the third direction D3. The plate-shaped portion 22A has, for example, through-holes 20d through which the screws 23A described above pass.

The second latch portion 20B includes a second protrusion 20c that engages with the thread grooves 5f of the second threaded portion 5h. The second protrusion 20c moves along the thread grooves 5f with the second protrusion 20c having entered the thread grooves 5f of the second threaded portion 5h. Accordingly, the second latch portion 20B and the second gripping portion 30B move along the axis L. The second protrusion 20c protrudes from the plate-shaped portion 21B in the direction opposite to the second direction D2. The second protrusion 20c is located at an end portion of the plate-shaped portion 21B in the first direction D1. The second protrusion 20c extends along the third direction D3 from an end portion of the plate-shaped portion 21B in the direction opposite to the third direction D3. The length of the second protrusion 20c in the third direction D3 is smaller than the length of the plate-shaped portion 21B in the third direction D3.

Next, an example of the material of each component of the mechanical chuck 1 will be described. The material of the base 2 is, for example, aluminum. The material of the rotary member 5 is, for example, stainless steel. The material of the first latch portion 20A and the second latch portion 20B is, for example, phosphor bronze. In this case, the first latch portion 20A and the second latch portion 20B can be easily flexed by a resistance force to be described later. However, the material of the first latch portion 20A and the second latch portion 20B may be steel use stainless (SUS), and can be changed as appropriate.

The material of the first slide portion 31A and the second slide portion 31B is, for example, aluminum. The material of the first claw portion 32A and the second claw portion 32B is, for example, stainless steel. In this case, since the first claw portion 32A and the second claw portion 32B can have appropriate elasticity, gripping of the component P by the first claw portion 32A and the second claw portion 32B can be appropriately performed. For example, when the first claw portion 32A and the second claw portion 32B are closed to grip the component P, an elastic force acts on the first claw portion 32A and the second claw portion 32B in a direction toward each other. Therefore, even when the first claw portion 32A and the second claw portion 32B are slightly separated from each other from a state in which the component P is gripped, the component P can be prevented from falling by the elastic force. The material of the first claw portion 32A and the second claw portion 32B may be a cemented carbide, and can be changed as appropriate.

Next, a component disposition method according to the present embodiment will be described. Hereinafter, operations of respective portions of the mechanical chuck 1 when the component P is gripped using the mechanical chuck 1 will be described. This component disposition method is performed while observing the component P to be gripped through a microscope. First, as illustrated in FIG. 6, the component P is disposed at an initial position (a step of disposing the component at the initial position). Next, the first gripping portion 30A and the second gripping portion 30B are disposed to sandwich the component P therebetween at positions where the distance from the component P to the first gripping portion 30A and the distance from the component P to the second gripping portion 30B are substantially equal (a step of disposing the first gripping portion and the second gripping portion).

The rotary member 5 is rotated with the first gripping portion 30A and the second gripping portion 30B disposed as described above (a step of rotating the rotary member). As illustrated in FIGS. 1, 2, and 3, for example, when the rotary member 5 is rotated counterclockwise as viewed along the first direction D1, the first protrusion 20b of the first latch portion 20A moves along the thread grooves 5c of the first threaded portion 5d, and the second protrusion 20c of the second latch portion 20B moves along the thread grooves 5f of the second threaded portion 5h.

At this time, as the first threaded portion 5d rotates, the first protrusion 20b moves along the thread grooves 5c, thereby causing the first latch portion 20A to move along the axis L, and as the second threaded portion 5h rotates, the second protrusion 20c moves along the thread grooves 5f, thereby causing the second latch portion 20B to move along the axis L in a direction opposite to the first protrusion 20b (in a direction toward the first latch portion 20A) (a step of moving the first latch portion and the second latch portion). Accordingly, the first arm 10A and the second arm 10B move in a direction toward each other, and the first gripping portion 30A and the second gripping portion 30B grip the component P (a step of gripping the component).

When rotation of the rotary member 5 is further continued with the first gripping portion 30A and the second gripping portion 30B gripping the component P, the first gripping portion 30A and the second gripping portion 30B receive a reaction force that hinders the above-described movement. That is, the first gripping portion 30A and the second gripping portion 30B receive a reaction force that hinders movement of the first arm 10A and the second arm 10B in a direction toward each other. At this time, the first latch portion 20A rides over the thread ridges 5k of the first threaded portion 5d in the direction opposite to the first direction D1, and the second latch portion 20B rides over the thread ridges 5p of the second threaded portion 5h in the first direction D1.

For example, when a repulsive force of 20 g or more is received as the reaction force that hinders the above-described movement, the first latch portion 20A rides over the thread ridges 5k in the direction opposite to the first direction D1, and the second latch portion 20B rides over the thread ridges 5p in the first direction D1. At this time, the first protrusion 20b of the first latch portion 20A rides over the thread ridges 5k in the direction opposite to the first direction D1, and the second protrusion 20c of the second latch portion 20B rides over the thread ridges 5p in the first direction D1. Accordingly, a force acts on the first arm 10A and the second arm 10B in a direction away from each other. However, as described above, when the first claw portion 32A and the second claw portion 32B are closed to grip the component P, an elastic force acts on the first claw portion 32A and the second claw portion 32B in a direction toward each other, so that the component P can be prevented from falling even when a force acts in a direction away from each other.

The first gripping portion 30A and the second gripping portion 30B grip the component P with the component P sandwiched between the first claw portion 32A and the second claw portion 32B, and dispose the component P at a target position (a step of disposing the component at the target position). For example, by applying an adhesive to the target position, disposing the component P on the applied adhesive, and curing the adhesive, the position of the component P is fixed (a step of fixing the position of the component). The series of steps of the component disposition method are completed through the steps described above.

The effects obtained from the mechanical chuck 1 according to the present embodiment will be described. In the mechanical chuck 1, the first threaded portion 5d and the second threaded portion 5h are formed on the rotary shaft 5b of the rotary member 5, and the first arm 10A and the second arm 10B move along the axis L as the rotary member 5 rotates. In the first arm 10A, the first latch portion 20A engages with the first threaded portion 5d, and the first gripping portion 30A moves along the axis L together with the first latch portion 20A. In the second arm 10B, the second latch portion 20B engages with the second threaded portion 5h, and the second gripping portion 30B moves along the axis L together with the second latch portion 20B. The first threaded portion 5d and the second threaded portion 5h are formed so as to be plane-symmetrical to each other with respect to the vertical plane S perpendicular to the rotary shaft 5b, the first latch portion 20A engages with the first threaded portion 5d, and the second latch portion 20B engages with the second threaded portion 5h. Therefore, when the rotary member 5 rotates, the first gripping portion 30A and the second gripping portion 30B move along the axis L in opposite directions at the same speed. Therefore, when the rotary member 5 rotates with the first gripping portion 30A and the second gripping portion 30B located on both sides of the component P, the first gripping portion 30A and the second gripping portion 30B are capable of approaching each other with respect to the component P at the same speed. As a result, the component P can be gripped between the first gripping portion 30A and the second gripping portion 30B with an appropriate gripping force.

The first latch portion 20A may ride over the thread ridges 5k of the first threaded portion 5d when the first gripping portion 30A, as the first gripping portion 30A moves along the axis L, receives a reaction force that hinders the movement. The second latch portion 20B may ride over the thread ridges 5p of the second threaded portion 5h when the second gripping portion 30B, as the second gripping portion 30B moves along the axis L, receives a reaction force that hinders the movement. In this case, when the first gripping portion 30A receives a reaction force that hinders the movement, the first latch portion 20A rides over the thread ridges 5k of the first threaded portion 5d, and when the second gripping portion 30B receives a reaction force that hinders the movement, the second latch portion 20B rides over the thread ridges 5p of the second threaded portion 5h. Therefore, when the first gripping portion 30A and the second gripping portion 30B further approach each other with the component P gripped between the first gripping portion 30A and the second gripping portion 30B, the first latch portion 20A and the second latch portion 20B ride over the thread ridges 5k and 5p due to resistance, thereby being able to prevent an excessive gripping force from being applied to the component P. Therefore, the gripping force applied to the component P can be further optimized.

The first latch portion 20A may include the first protrusion 20b that engages with the thread grooves 5c of the first threaded portion 5d, and the second latch portion 20B may include the second protrusion 20c that engages with the thread grooves 5f of the second threaded portion 5h. The first protrusion 20b may move along the axis L by moving along the thread grooves 5c of the first threaded portion 5d when the first threaded portion 5d rotates, and the second protrusion 20c may move along the axis L in the direction opposite to the first protrusion 20b by moving along the thread grooves 5f of the second threaded portion 5h when the second threaded portion 5h rotates. In this case, the first protrusion 20b of the first latch portion 20A and the second protrusion 20c of the second latch portion 20B move along the thread grooves 5c and 5f, respectively, thereby enabling the first gripping portion 30A and the second gripping portion 30B to move with high accuracy. Therefore, the gripping force applied by the first gripping portion 30A and the second gripping portion 30B can be adjusted with high accuracy.

The mechanical chuck 1 may include the guide member 4 that guides the movement of the first arm 10A along the axis L and the movement of the second arm 10B along the axis L. In this case, the movement of the first gripping portion 30A of the first arm 10A and the second gripping portion 30B of the second arm 10B along the axis L can be stabilized.

In the present embodiment, the motor 3 rotates the rotary member 5 to move the first arm 10A and the second arm 10B along the axis L in opposite directions, thereby enabling fine adjustment of the gripping force applied by the first gripping portion 30A and the second gripping portion 30B. That is, the motor 3 rotates the rotary member 5, thereby enabling fine adjustment of the rotation speed of the rotary member 5 and enabling the first arm 10A and the second arm 10B to move at low speed, so that the gripping force applied to the component P can be prevented from becoming excessive.

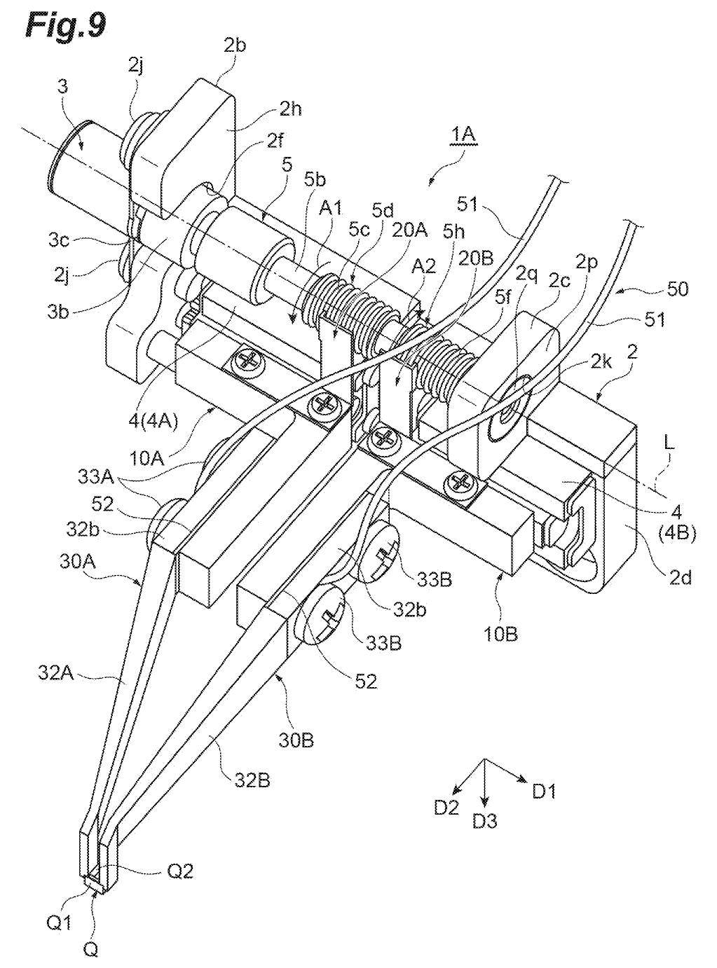

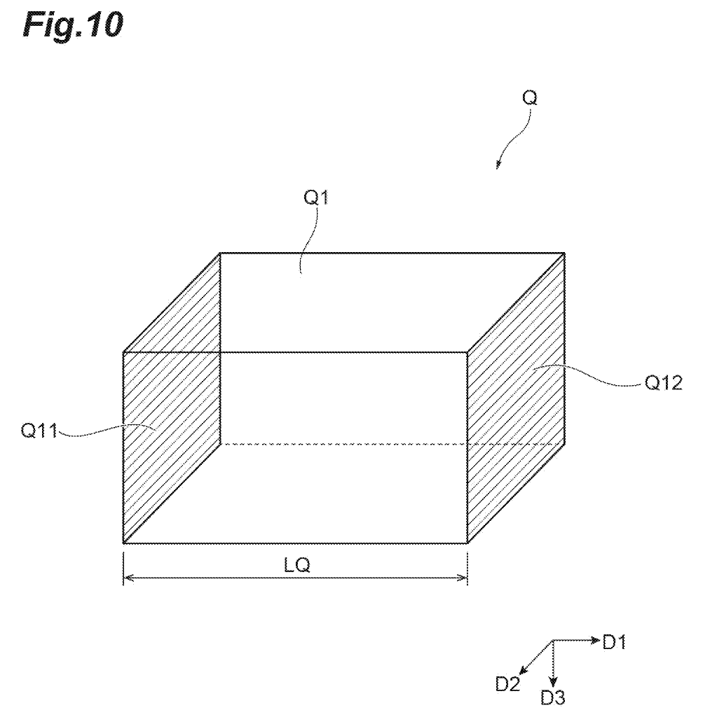

Next, a mechanical chuck 1A according to a modification example will be described with reference to FIGS. 9 and 10. FIG. 9 is a perspective view illustrating the mechanical chuck 1A. FIG. 10 is a perspective view illustrating a component Q gripped by the mechanical chuck 1A. A part of the configuration of the mechanical chuck 1A is identical to a part of the configuration of the mechanical chuck 1 described above. Therefore, hereinafter, descriptions that overlap with the those of the mechanical chuck 1 are omitted as appropriate with the same reference signs assigned.

The mechanical chuck 1A includes an energizing mechanism 50 that energizes the gripped component Q. The energizing mechanism 50 includes a wiring 51, an insulating member 52, the first claw portion 32A, and the second claw portion 32B. The first claw portion 32A and the second claw portion 32B are made of a conductive material. The energizing mechanism 50 includes two wirings 51. One wiring 51 is fixed to the first fixing portion 32b of the first claw portion 32A by the screws 33A, and the other wiring 51 is fixed to the second fixing portion 32h of the second claw portion 32B by the screws 33B. The screws 33A and the screws 33B are plastic screws.

The component Q includes, for example, a main body portion Q1 having a rectangular parallelepiped shape. The main body portion Q1 includes a first electrode portion Q11 and a second electrode portion Q12 provided at a position facing the first electrode portion Q11. For example, electric power can be supplied to the component Q by energizing the first electrode portion Q11 and the second electrode portion Q12. When the component Q is sandwiched between the first claw portion 32A and the second claw portion 32B described above, and a current flows to the wirings 51 to energize the first claw portion 32A, the first electrode portion Q11, the second electrode portion Q12, and the second claw portion 32B, the component Q can be electrically operated. For example, when a light-emitting element is mounted on the component Q, the mechanical chuck 1A can cause the light-emitting element to emit light by energizing the component Q while gripping the component Q. The component Q may have at least one of a protrusion and a recess for mounting the light-emitting element. An optical element other than the light-emitting element, which operates upon receiving a supply of electric power, may be mounted on the component Q. The component Q has a distance (length) LQ between the first electrode portion Q11 and the second electrode portion Q12 along the first direction D1. The distance LQ is, for example, 0.5 mm or more and 2 mm or less. When the component Q is not gripped, the shortest distance between the first claw portion 32A and the second claw portion 32B along the first direction D1 is smaller than the distance LQ. Accordingly, the component Q can be reliably gripped, and electric power can be stably supplied to the component Q.

The embodiment and the modification example of the mechanical chuck according to the present disclosure have been described above. However, the mechanical chuck according to the present disclosure is not limited to the contents of the embodiment or the modification example described above, and may be further modified within the scope of the concept described in the claims. That is, the shapes, sizes, materials, numbers, and disposition modes of the respective portions of the mechanical chuck according to the present disclosure can be changed as appropriate within the scope of the concept.

For example, in the embodiment described above, an example in which the plate-shaped portion 22A of the first latch portion 20A is fixed to the first gripping portion 30A by the screws 23A and the plate-shaped portion 22B of the second latch portion 20B is fixed to the second gripping portion 30B by the screws 23B has been described. Further, an example in which the first fixing portion 32b of the first claw portion 32A is fixed to the protruding portion 31c of the first slide portion 31A by the screws 33A and the second fixing portion 32h of the second claw portion 32B is fixed to the protruding portion 31f of the second slide portion 31B by the screws 33B has been described. However, the means for fixing the respective components of the mechanical chuck 1 may be other than screws, and can be changed as appropriate.

What is claimed is:

1. A mechanical chuck comprising:
a rotary member including a rotary shaft, a first threaded portion that is a portion in which thread grooves are formed on the rotary shaft and which extends along an axis of the rotary shaft, and a second threaded portion that is a portion in which thread grooves are formed on the rotary shaft and which is configured to be plane-symmetrical to the first threaded portion with respect to a vertical plane perpendicular to the rotary shaft; and
a first arm and a second arm that move along the axis as the rotary member rotates,
wherein the first arm includes a first latch portion that engages with the first threaded portion, and a first gripping portion that moves along the axis together with the first latch portion,
the second arm includes a second latch portion that engages with the second threaded portion, and a second gripping portion that moves along the axis together with the second latch portion, and
the first gripping portion and the second gripping portion move along the axis in opposite directions as the rotary member rotates.

2. The mechanical chuck according to claim 1,
wherein the first latch portion rides over thread ridges of the first threaded portion when the first gripping portion, as the first gripping portion moves along the axis, receives a reaction force that hinders the movement, and
the second latch portion rides over thread ridges of the second threaded portion when the second gripping portion, as the second gripping portion moves along the axis, receives a reaction force that hinders the movement.

3. The mechanical chuck according to claim 1,
wherein the first latch portion includes a first protrusion that engages with the thread grooves of the first threaded portion,
the second latch portion includes a second protrusion that engages with the thread grooves of the second threaded portion,
the first protrusion moves along the axis by moving along the thread grooves of the first threaded portion when the first threaded portion rotates, and
the second protrusion moves along the axis in a direction opposite to the first protrusion by moving along the thread grooves of the second threaded portion when the second threaded portion rotates.

4. The mechanical chuck according to claim 1, further comprising:
a guide member that guides the movement of the first arm along the axis and the movement of the second arm along the axis.
